(19) United States
(12) Patent Application Publication
(10) Pub. No.: US 2008/0291214 A1
(43) Pub. Date: Nov. 27, 2008

(54) Theme Picture Promotional Photography and Theme Picture Composition Guide for Electronic Camera Display

(76) Inventor: David Wasserman, Atlanta, GA (US)

Correspondence Address: MEHRMAN LAW OFFICE, P.C., P.O. Box 420797, ATLANTA, GA, 30342, US

(21) Appl. No.: 12/127,575

(22) Filed: May 27, 2008

Related U.S. Application Data
(60) Provisional application No. 60/939,940, filed on May 24, 2007.

(51) Int. Cl. G09G 5/00; H04N 5/228

(52) U.S. Cl. 345/619; 348/222.1; 348/E05.031

(57) ABSTRACT

Theme picture promotional photography, in which the subject image is captured using a temporary composition guide attached to the electronic display on a digital camera. The theme picture composition guide includes an image overlay depicting content to be added to the captured image post-capture to create a theme picture. The theme picture may be printed on-site, and it may also be displayed or distributed in association with a client website to promote electronic traffic to the client website.

### TECHNICAL FIELD

The present invention generally relates to digital photography and, more particularly, to a theme picture composition guide configured for temporary attachment to the display on an electronic camera that includes an image overlay depicting content to be added to the captured image post-capture to create a theme picture.

### BACKGROUND

Event sponsors and advertisers are increasingly looking for ways to maximize the money that is spent on promoting products and services. For example, sponsors and advertisers often give away souvenirs at events in an attempt to have the attendee of the event remember the event and the product or service being promoted long after the event has ended. Promotional photographs are often desirable souvenirs, since they are personalized to the attendees, the specific experiences, and events of the event day. Promotional photographic souvenirs can be used to create especially favorable and lasting impressions for an event sponsor or advertiser. At the same time, care should be taken to ensure that the photograph taking process is as convenient and favorable as possible for the event attendees Competition has therefore developed in the provision of promotional photography services, which often form an important part of an event.

For an event sponsor or promoter, an “event” may be any meeting or gathering having a large number of customers or potential customers. For example, an event may be a sporting event, a festival, a concert, an auto race, a promotional tour, a trade show, auto show, and the like. The event sponsor or advertiser often hires a professional promotional photographer or agency to work at the event, taking and distributing promotional photographs. The promotional photographer, therefore, has a need for effective techniques and products for applying this trade at these events.

Events suitable for promotional photography often attract a large number of people, many with at least a few moments of time that can be spared to have a picture taken. An event sponsor or promoter may wish to provide attendees with picture-souvenirs that also serve as a reminders of the event, including products or services advertised at the event or otherwise associated with the event sponsors. If the customer enjoys the event, the picture-souvenir may help to associate the event with a favorable impression of the advertiser or marketer who supplied the picture-souvenir. Further, organizations other than consumer-product marketers may also wish to use such photographs to increase their exposure and visibility, such as durable-goods manufacturers, automotive manufacturers, service-providers, and the like. In most instances, the success of the promotional photograph may be enhanced if the photograph is interesting or humorous. It is also generally beneficial if the process of having one's picture taken for the promotional photograph is and convenient or even and enjoyable event.

In recent years, the business of promotional photography has become increasingly competitive. Promotional photographers and agencies, particularly those catering to large events, are increasingly looking for ways to enhance and distinguish their products and services. For example, “theme pictures” are one way of distinguishing picture-souvenirs. A theme picture generally includes a composite image in which a captured image, such as a customer at an event, is combined with other content to apparently place the customer in an interesting or humorous scene. For example, content can be added to the customer's image to place the customer in a scene in which the customer is in a bull fight, riding on a surfboard, or standing next to a celebrity. Theme pictures are sometimes taken in front of a special uniformly colored screen (e.g., a green screen) background that allows easy manipulation of the image such that an additional image, such as person, place or thing creating a theme for the composite picture (e.g., celebrities, athletes, mascots) can be placed alongside the person being photographed. With more advanced post-capture manipulation, theme pictures can be created from ordinary photographs that are not taken in front of special uniformly colored screens.

While theme pictures have been successful tools for promotional photography, there have been limitations to their application. For example, a computer is generally employed in conjunction with the digital camera to allow the photographer to view a composite image including the captured image in combination with elements to be added to image post-capture on the computer screen to allow for correct placement of the person within the theme picture scene. As a result, the theme picture system, typically including a camera and associated computer, is more cumbersome and less mobile than a camera alone, which can limit the use of the system at an event to a kiosk or photo booth where the theme pictures are staged. As kiosk or photo booth space is inherently limited, this generally creates an obstacle to servicing thousands of event attendees in an expeditious manner.

While an advertiser or sponsor has an opportunity to create a favorable impression by providing an image with pleasant associations, there is also the possibility that negative impressions may be formed if the process does not go smoothly. For example, long wait lines at photo booths can create a negative impression of an event to the detriment of the sponsor.

Accordingly, a need exists for more effective and convenient techniques for promotional photography including theme pictures and other types of composite images through digital photography.

### SUMMARY OF THE INVENTION

The present invention meets the needs described above in a theme picture composition guide, configured for temporary attachment to the display on an electronic camera, that includes an image overlay depicting content to be added to the captured image post-capture to create a theme picture. The theme pictures can be printed on-site, for example at special events, or they can be provided by email or online through a client website to drive website traffic to the client website.

Generally described, the theme picture background content to be added to photos taken at an event is captured or created in advance of the event. The theme picture background content is then reduced and printed onto a transparent image overlay, which is removably attached to the electronic display on the electronic camera to create a theme picture composition guide. Typically, a few test theme picture are taken with the theme picture composition guide to ensure that composition guide as shown on the electronic display is an accurate reflection of the theme picture background content that will be added to the captured image to create the theme picture. The composition guide may then be resized or otherwise adjustments as needed. Different theme picture composition guides can be created for different theme picture background content, and multiple copies of the theme picture composition guides can be easily printed to a transparent substrate. The transparent substrate is held to the camera display through static charge or a light adhesive.

In the typical promotional photography application, the theme picture composition guides to be used at an event are created in advance of the event. A selected theme picture composition guide containing an image overlay of theme picture background content is then attached to the electronic display on a camera at the event. Different theme picture composition guide can be attached to and removed from the camera, as need. Multiple mobile cameras, photo kiosks and/or photo booths with associated supplies of theme picture composition guides, typically printed on pre-cut contact sheets, may be dispatched at a particular event. A given camera is then used to capture a subject image using a theme picture composition guide to align the subject with the theme picture background content shown on the composition guide. The subject image is combined post-capture with the theme picture background content to create a theme picture containing the subject image and the theme picture background content.

The theme picture created in this manner may then be printed on-site and/or emailed to an email address provided by a customer, which is typically the person depicted as the subject in the theme picture. Alternatively or in addition, the theme picture may be published on or provided through a client website, such as a website associated with an event sponsor, promoter or advertiser, to drive the customer to that website, where they may be presented with advertising or other content associated with the client. The theme pictures may be provided to the customer for free, or they may be charged for the photos.

Although the theme pictures may be hosted directly on the client website, it is often more convenient and efficient to have the customers select the photos from the client website, and to have the theme pictures loaded to the customer's browser on demand from a separate photo server. As a result, the theme pictures can be actually created only when a customer takes the predefined action necessary to trigger the creation of the theme photograph. This avoids the creation and storage of theme pictures that are never accessed by customers. Serving the theme photographs from a photo server separate from the client website advantageously minimizes the functional changes and data storage requirements of the client website necessary to accommodate the promotional photography website program.

The above described and other features are exemplified by the following Figures and detailed description.

### BRIEF DESCRIPTION OF THE DRAWINGS

FIG. 1 is a rear exploded view of a camera with a theme picture overlay for attachment to the camera display.

FIG. 2 is a rear view of a camera with a theme picture composition guide attached to the camera display.

FIG. 3 shows a theme picture composition guide cut to size for attachment to the electronic display on a digital camera.

FIG. 4 shows a contact sheet containing a number of theme picture composition guides.

FIG. 5 is a perspective view of a window for placing a theme picture composition guide over a camera display.

FIG. 6 is a side view of the window for placing a theme picture composition guide over a camera display.

FIG. 7 is a perspective view of a camera with a window carrying a theme picture composition guide placed over the camera display.

FIG. 8 is rear view of a camera with a theme picture composition guide attached to the camera display.

FIG. 9 is rear view of a camera showing a subject in the camera display without a theme picture composition guide.

FIG. 10 is rear view of a camera showing in the camera display with a theme picture composition guide attached to the camera display.

FIG. 11 is a conceptual illustration of a print containing a theme picture background.

FIG. 12 is a conceptual illustration of a print containing a subject of a picture shown without a theme picture background.

FIG. 13 is a conceptual illustration of a print containing a subject of a picture shown with a theme picture background.

### DETAILED DESCRIPTION OF THE EMBODIMENTS

The invention may be embodied in theme picture composition guides for a digital camera and in theme picture promotional photography using the theme picture composition guides. Theme picture promotional photography may be described as commercial photography in which the subject image is captured using a temporary composition guide attached to the electronic display on the camera. The theme picture composition guide includes an image overlay depicting content to be added to the captured image post-capture to create a theme picture. The theme picture may be printed on-site or emailed to selected address, and it may also be displayed or distributed in association with a client website to promote electronic traffic to the client website. Of course, the composition guides may also be used for personal or any other type of photography.

The theme picture composition guide may be temporarily attached to a viewfinder or display of a camera device. The theme picture composition guide typically includes an image overlay depicting content to be added to the captured image post-capture to create a theme picture. In particular, the image overlay may include a scaled image of the theme picture background content that, when attached to the electronic display on a digital camera, allows the user to position an object or person within the theme picture scene. Corresponding theme picture content is then added (and captured image content may be removed) during post-capture processing to create the theme picture. The term “post-capture processing” as used throughout this disclosure generically refers to any manipulation of a digitally captured imaged. For example, post processing generally employs a processing device (e.g., a computer) capable of executing a set of instructions (e.g., a program) that may add or remove images from a captured image or modify the captured image (e.g., by adding text).

FIG. 1 is a conceptual exploded illustration of a digital camera 10 that includes an electronic display 12, a view finder 14, and a camera body 16. The display 12 is provided at the approximate center of a back face of the digital camera 10 within the camera body 16. The display 12 is useful in previewing the image that is to be captured, for playing back a recorded image, displaying a menu of various settings, and the like. In various embodiments, the display 12 can include a liquid crystal display (LCD), a plasma display, organic electroluminescence (EL) display, and the like. The camera also includes other items typical for cameras, such as a release button that is useful for instructing the start and/or stop of a photographing operation (exposure), and function buttons that are useful for reviewing digital images stored in the digital camera, for instructing the zooming functions, and the like.

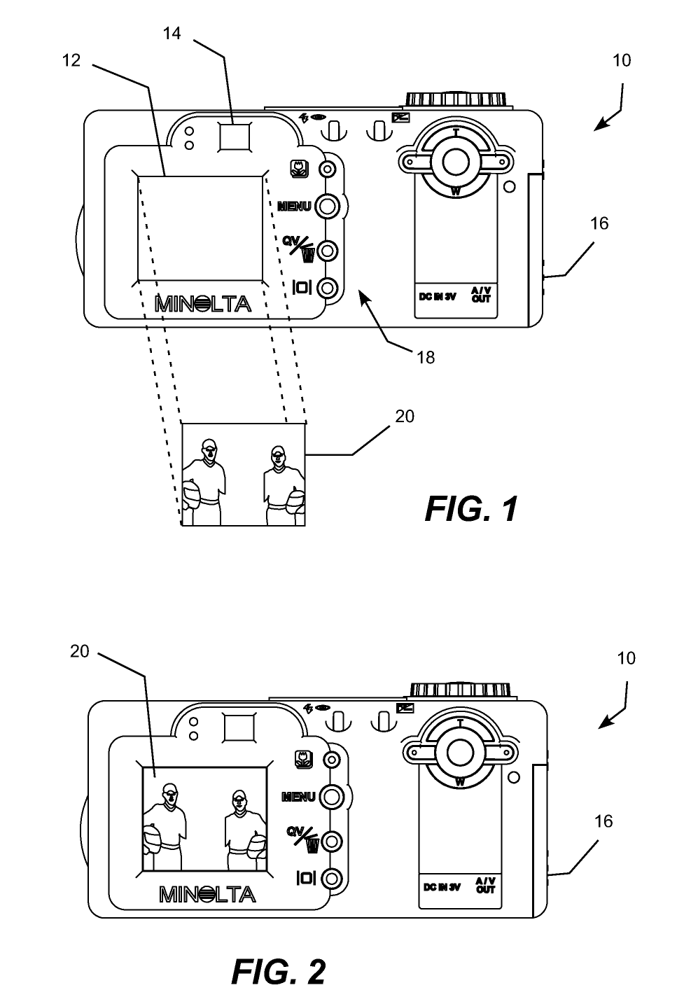

The camera 10 can be used to capture a theme picture by placing a theme picture composition guide 20 on the camera display 12. The theme picture composition guide 20 is typically configured for attachment to the built-in camera display provided on most digital cameras. Nevertheless, it should be appreciated that the theme picture composition guide may be attached to an auxiliary camera display, such as a separate external display, such as a stand-alone display or a computer screen, to which the camera is operationally connected. The theme picture composition guide 20 contains content, typically printed onto a transparent substrate, Acetate®, Mylar® or another suitable material. The image printed on the composition guide corresponds to theme picture background content that will be added to the captured image post-capture to create a theme picture. The theme picture composition guide 20 assists the camera operator in positioning the subject of the picture with respect to the content depicted on the overlay, which corresponds to theme picture background content to be added to the captured image post-capture to create the theme picture. The theme picture overlay 20 is removably attached to the camera display 12, for example by static electricity or a light adhesive. The adhesive should be relatively lightly affinity for the camera display and a significantly higher affinity for the substrate so that adhesive does not come off the substrate and stick to the camera display. The adhesive used on Post-It Notes® is believed to be suitable for this purpose. Of course, a similar overlay can be provided for the view finder 14, but the larger size of the camera display 12 provides for a more convenient place to temporarily attach the theme picture overlay. FIG. 2 shows the camera 10 after the theme picture overlay 20 has been attached to the camera display 12.

While reference has been made to a digital camera for convenience in discussion, it should be understood that other embodiments are envisioned to be within the scope of this disclosure. For example, other camera devices include, but are not limited to, a camera phone, a mobile terminal, or other devices incorporating a digital camera. Mobile terminals may include, but are not limited to, cellular radiotelephones, personal communication services (PCS) devices, personal digital assistants (PDAs), laptop computers, BlackBerry® devices, and palm-top computers.

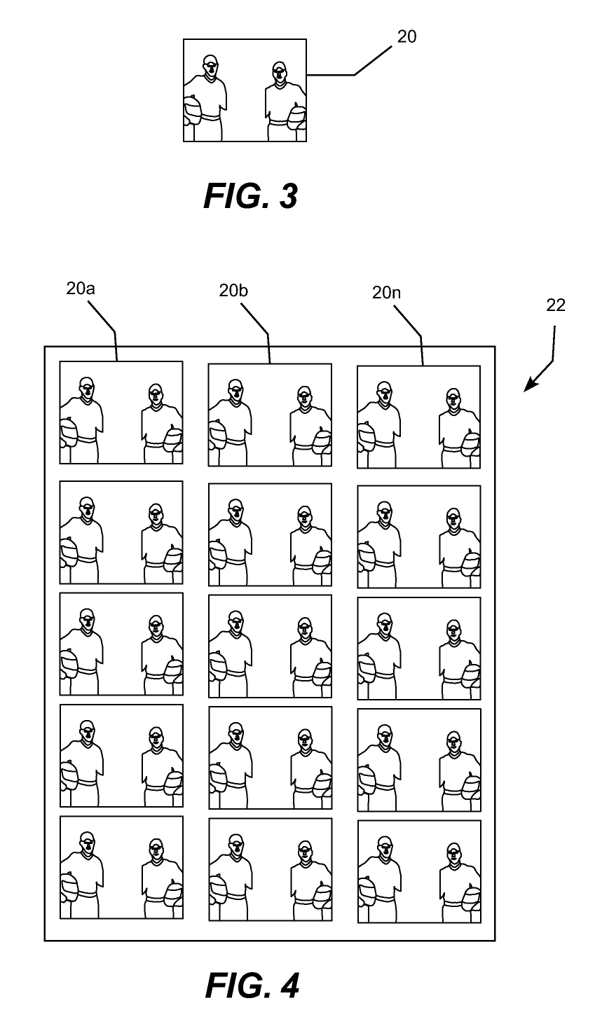

FIG. 3 shows a theme picture composition guide 20 cut to size for attachment to the electronic display on a digital camera. The theme picture composition guide 20 may be extended on one side or include a tab or handle to assist the operator in placing the composition guide on the camera display. The composition guide may also include a printed frame, corners, cross-hairs or other visible indicia to assist the operator in locating the composition guide in the correct location on the camera display. Page-sized adhesive sheets with a matrix with die-cut panels appropriate sized for the electronic display on the intended camera may be used. Sheets of different sizes of die-cut panels may be provided for cameras with differently sized electronic displays. A software application that runs on a conventional personal computer may be used to help the user create the image overlays containing the theme picture background content, size the image overlays for the desired camera, and print them on the adhesive sheets. The software application may be configured as a downloadable applet or module that configured to operate as and add-on feature for more comprehensive image processing software, such as Photo Shop® or any other suitable program. This will allow the user access to photographs, photographic components, clip-art, and image processing tools when crating the image overlays. The image processing system may also be used during the post-capturing process to add the theme picture background content to the captured images and otherwise clean up and further manipulate the theme pictures, as desired. For example, the user may remove undesired content, add a border, add an electronic signature of a celebrity, and make other post-capture modifications, as desired.

FIG. 4 shows a contact sheet 22 containing a number of theme picture composition guides 20a-n. This type of contact sheet with multiple copies of the same theme picture composition guide is useful when multiple photographers will be working an event using the same theme picture background. In addition, contact sheets can be printed with a variety of different theme picture composition guides, which the photographer can select and use as desired.

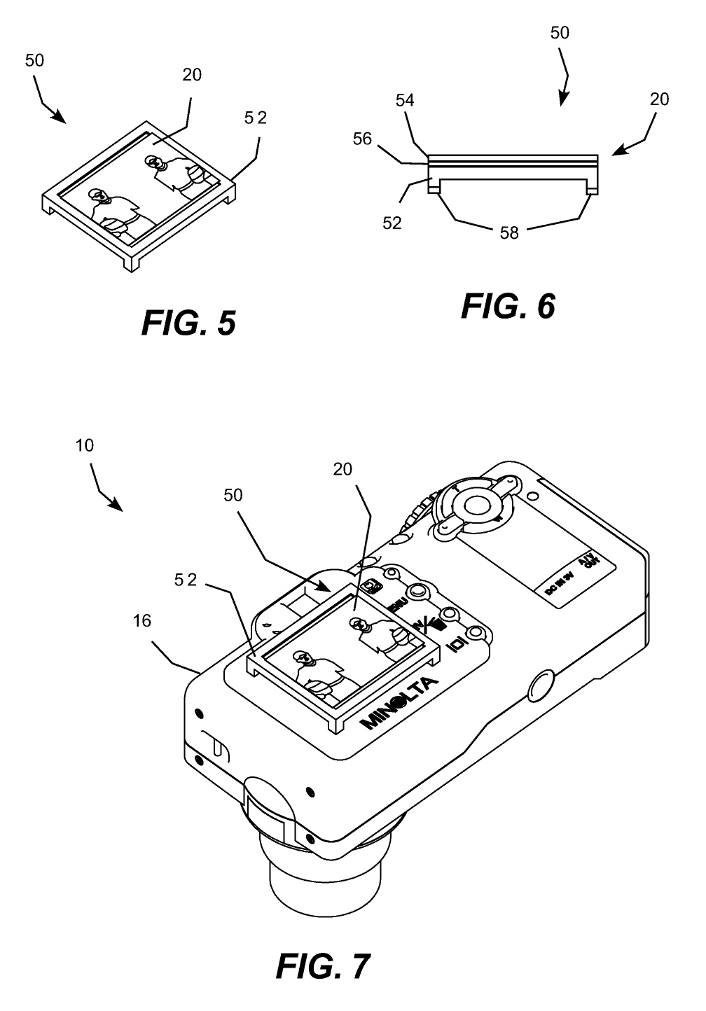

FIG. 5 is a perspective view of a window 50 for placing the theme picture composition guide 20 over the camera display. FIG. 6 is a side view of the window 50. In this embodiment, the window 50 receives the theme picture composition guide 20 to avoid touching or placing adhesive directly on the camera display itself. The window 50 typically includes a transparent material 56, such as glass, held by a frame 52. In this example, the composition guide 20 includes a substrate 54 and an adhesive 56, which holds the substrate 54 of the composition to the transparent material 56 of the window. As shown in FIG. 7, the window 50 is then placed over the camera display with the frame 52 attached to the camera body 16 so that the composition guide overlays the camera display. For example, the window may be firmly glued to the camera body or removably attached with small pads or strips of Velcro or other suitable fasteners. In one embodiment, the frame 52 comprises a plastic (e.g., polycarbonate such as Lexan®, which is commercially available from GE). When the window 50 is attached to the camera over the display 12, it may advantageously serves to protect the display from damage (e.g., scratching).

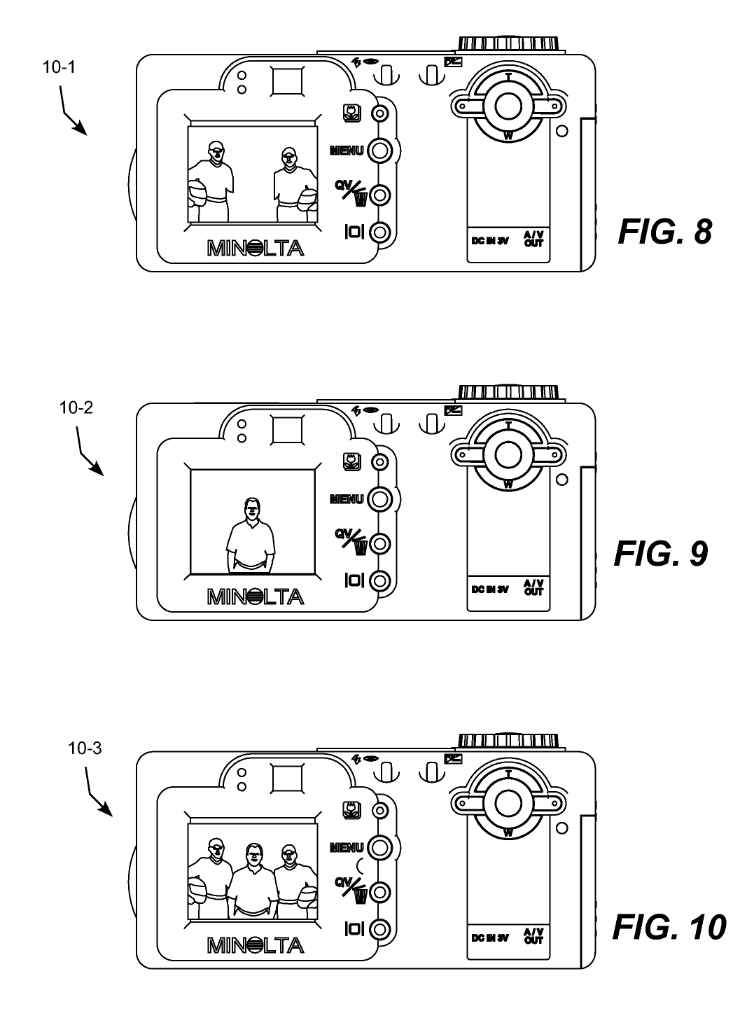

FIG. 8 shows a view of a camera 10-1 with the theme picture composition guide attached to the camera display, FIG. 9 shows a view 10-2 with a subject shown in the camera display without a theme picture composition guide, and FIG. 10 shows a view 10-3 with the subject shown in the camera display along with the theme picture composition guide placed over the camera display. The objective of the theme picture composition guide is to assist the operator in locating the subject with respect to the theme picture composition guide, as show in view 10-3.

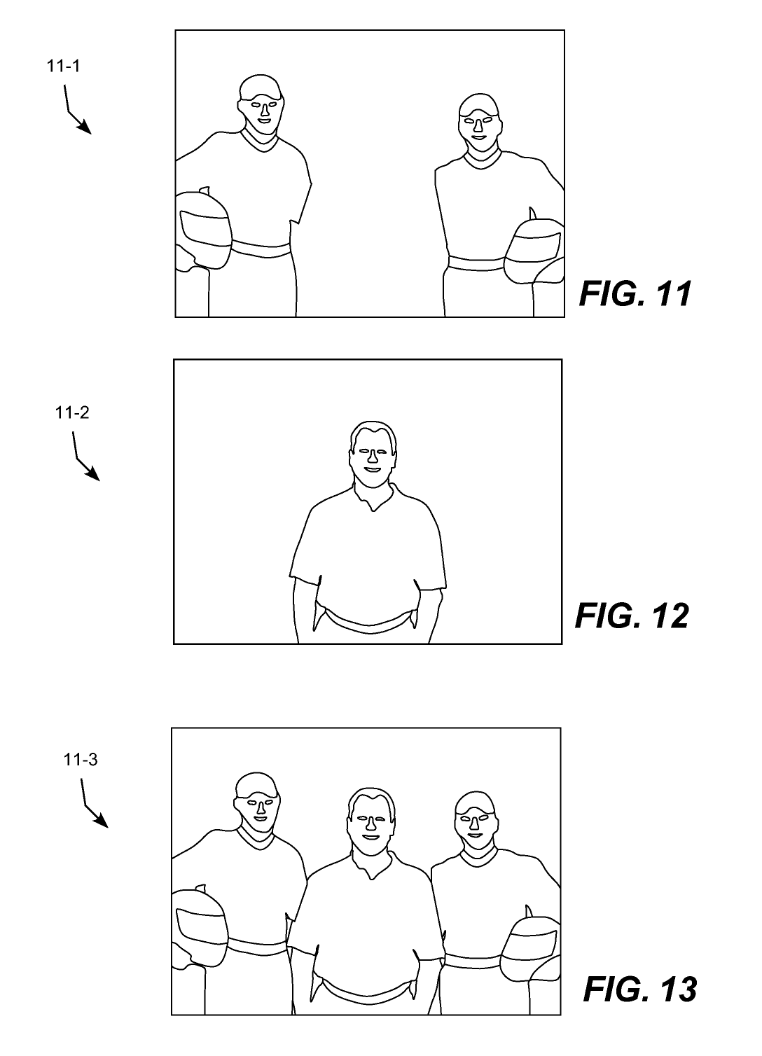

FIG. 11 illustrates a print 11-1 containing the theme picture background, FIG. 12 illustrates a print 11-2 of the subject without the theme picture background, and FIG. 13 illustrates of a print 11-3 containing a subject and the theme picture background. The theme picture background shown in print 11-1 corresponds to the content carried on the theme picture composition guide 10-1 shown in FIG. 8. The composition guide 10-1 is used pre-capture to align the subject with the content depicted on the composition guide, whereas that same content is added post-capture as theme picture background to create the theme picture 11-1. Of course, any type of content may be depicted on a composition guide and added as theme picture background to capture and print theme pictures.

In one embodiment, the digital camera 10 includes a body portion 16 having dimensions that are less than or equal to dimensions of a display or viewfinder of the digital camera device, wherein the body portion comprises an at least partially visually transparent material; and an image portion disposed on a first side of the body portion, wherein the image portion is representative of a pre-set image to be added to a captured image by the digital camera.

A method for creating a theme picture includes capturing an image comprises disposing an apparatus in operable communication with a display or viewfinder of a digital camera, aligning a subject whose image is to be captured with the image portion, and capturing the image of the subject to form a captured image. The apparatus comprises a body portion having dimensions that are less than or equal to dimensions of the display or the viewfinder of the digital camera device, and wherein the body portion comprises an at least partially visually transparent material; and an image portion disposed on a first side of the body portion, wherein the image portion is representative of a pre-set image to be added to a captured image by the digital camera.

A digital camera device typically comprises a camera body; a viewfinder disposed in operable communication with the camera body; a display disposed in operable communication with the camera body; and an apparatus disposed in operable communication with the viewfinder or the display. The apparatus comprises a body portion having dimensions that are less than or equal to dimensions of the display or the viewfinder of the digital camera device, and wherein the body portion comprises an at least partially visually transparent material; and an image portion disposed on a first side of the body portion, wherein the image portion is representative of a pre-set image to be added to a captured image by the digital camera.

The content depicted in the theme picture composition guide comprises a scaled image of an image to be added to a captured digital image taken with the digital camera. Scaling of the image is a mathematical calculation that can readily be performed by one of skill in the art without unreasonable experimentation, especially with the aid of a computer or other calculation device. In scaling the image, a number of variables are considered that include, but are not limited to, the size of the display 12, the distance away from the display that the composition guide 20 will be mounted (for example, on the window 50), the desired placement within the captured image, and the post processing program (e.g., software) to be used. The content depicted on the composition guide 20 may be exact replica of the theme picture background content to be added to the print post-capture, or it may be a rough outline of the image to be produced. In one embodiment, the composition guide 20 may be in the form of an adhesive laminate (e.g., sticker, adhesive label, and the like). The adhesive may be any suitable adhesive that allows the composition guide 20 to be attached to the display 12 or the window 50 without significantly impairing the user's ability to see the display 12. Accordingly, the adhesive used (if and) should be at least partially transparent. The adhesive portion may also be a pressure-sensitive.

At an event, the composition guide 20 is attached to the digital camera 10 without having to be attached to a computer, thereby giving the user mobility in operation, as well as speed and accuracy in capturing an image. In operation, the user of the camera 10 either looks or the display 12, aligns the subject with the image depicted in the composition guide, and captures the image. The captured images are periodically transferred to a processing device (e.g., once a day, periodically in batches, and the like). The processing device is any device in which images can be viewed and a set of instructions can be executed. For example, the processing device may be a personal computer.

Before the image is provided to the event attendee, the image is post processed using the processing device. In particular, the theme picture background content corresponding to the composition guide is added to the captured image to create the theme picture. The theme picture background content may be the likeness of a person (e.g., a celebrity, athlete, and the like), an object (e.g., a racecar, a boat, and the like), an animal (e.g., a racehorse, and the like), and the like. In addition to the theme picture background content, other modifications may be made to the captured image. For example, various optional designs and logos around a border of the image may be added. Further, the background or foreground of the picture may be changed, as is readily understood by those skilled in the art.

After completing the post processing of the captured image, the theme picture may be delivered to the event attendee as a picture souvenir. For example, the picture souvenir may be generated immediately at the event. In other embodiments, the theme picture may be emailed to the event attendee, mailed to the event attendee, or posted on a website so the user may retrieve it at his or her convenience. In one embodiment, traffic can be driven to the advertiser's/sponsor's website to obtain the picture, thereby further maximizing the value of the advertiser's/sponsor's promotion expenses. Additional information about the user can optionally be collected during the process of receiving the theme pictures. For example, the advertiser/sponsor may ask survey questions of interest to the advertiser/sponsor.

In one embodiment, the event attendee can receive an identifier such as the URL of the website where the theme picture can be obtained by a card or coupon printed with the identifier and URL after his or her image has been captured. The identifier may be unique to a particular theme picture image captured such that event attendees cannot view images of other event attendees. At the website, the user will enter the identifier associated with the image in order to obtain a copy of the picture souvenir.

In various other embodiments, the picture souvenir may be embodied in another form other than a photograph. For example, the theme picture may be printed on articles of clothing (e.g., T-shirts), articles (e.g., beverage containers), and the like. Further, it is to be understood that various other promotional techniques as are readily understood by those skilled in the art can be employed with the apparatus and photographing methods disclosed herein.

Advantageously, the apparatus for the digital camera device disclosed herein allows the photographer to generate composite theme pictures while being mobile. More particularly, the apparatus allows the photographer to place people or objects within a scene without having to preview the composite image on a computer monitor while capturing the image. Since the apparatus reduces the time to capture an image, the photographer can service a larger volume of event attendees.

Once a subject image has been captured using a theme picture composition guide, and described above, corresponding theme picture content is typically added to the subject image through post-capture processing to create the theme picture. The theme picture can them be printed on-site and handed to a customer, such as the subject of the theme picture. The theme picture may also be uploaded to a photo server and emailed to an address obtained from the customer. Alternatively or in addition, the customer may be permitted to access and download the theme picture through a client website. In the promotional photography content, the client is usually an event sponsor, promoter or advertiser and the customer serving ad the subject of the theme picture is an event attendee. Allowing the customer to access and download the theme picture through the client's website drives traffic to the client's website, where the customer may be exposed to advertising or content selected by the client. Of course, the customer could be charged a fee for electronic or print copies of the theme pictures, and the revenue may be shared among the photographer, the client, other sponsors of the event, and so forth.

Although the theme pictures may be hosted directly on the client website, it is often more convenient and efficient to have the customers select the photos from the client website, and to have the theme pictures loaded to the customer's browser on demand from a separate photo server. As a result, the theme pictures can be actually created only when a customer takes the predefined action necessary to trigger the creation of the theme photograph. This avoids the creation and storage of theme pictures that are never accessed by customers. Serving the theme photographs from a photo server separate from the client website advantageously minimizes the functional changes and data storage requirements of the client website necessary to accommodate the promotional photography website program.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method for creating a theme picture, comprising the steps of:
providing a digital camera comprising a camera display;
providing a composition guide comprising a viewing area sized and shaped to correspond to the camera display;
printing an image depicting theme picture content on the composition guide within the viewing area;
removably attaching the composition guide to the camera with the viewing area overlying the camera display;
positioning a subject image created by the camera on the camera display in a desired positional relationship to the theme picture content;
capturing an image of the subject with the camera;
creating a print including the captured image; and
adding theme picture content to the print corresponding to the theme picture content depicted on the theme picture composition guide.

3. A theme picture device, comprising:
a digital camera comprising a camera display;
a composition guide comprising a viewing area removably attached to the camera display; and
wherein the composition guide depicts theme picture content to be added to an image captured by the camera post-capture to create a theme picture.

2. A theme picture composition guide for a digital camera, comprising;
a transparent substrate comprising a viewing area sized and shaped to fit over a digital display of a digital camera; and
an image carried on the transparent substrate in the viewing area depicting theme picture content to be added to an image captured with the camera post-capture to create a theme picture.
